(19) United States
(12) Patent Application Publication
(10) Pub. No.: US 2017/0104261 A1
(43) Pub. Date: Apr. 13, 2017

(54) COMMUNICATION DEVICE

(71) Applicant: Acer Incorporated, New Taipei City (TW)

(72) Inventors: Kin-Lu WONG, New Taipei City (TW); Chih-Yu TSAI, New Taipei City (TW)

(21) Appl. No.: 14/937,025

(22) Filed: Nov. 10, 2015

(30) Foreign Application Priority Data
Oct. 8, 2015 (TW) 104133163

(51) Int. Cl. H01Q 1/24; H01Q 5/20

(52) U.S. Cl. CPC H01Q 1/243; H01Q 5/20

(57) ABSTRACT

A communication device includes a housing, a system circuit board, and an antenna element. A metal plane of the housing is disposed on a back surface of the housing. An edge of the metal plane is aligned with an edge of the back surface. The antenna element includes a metal piece and a printed circuit board. The metal piece is disposed on a side surface of the housing. The metal piece extends along the edge of the metal plane. The metal piece is also separated from the edge of the metal plane by a nonconductive region. The printed circuit board includes a circuit. The printed circuit board has a first connection point and a second connection point. The first connection point is coupled to a signal source. The second connection point is coupled to the metal piece, and is used as a feeding point of the antenna element.

### CROSS REFERENCE TO RELATED APPLICATIONS

This Application claims priority of Taiwan Patent Application No. 104133163 filed on Oct. 8, 2015, the entirety of which is incorporated by reference herein.

### BACKGROUND OF THE INVENTION

Field of the Invention

The disclosure generally relates to a communication device, and more particularly, to a tablet communication device with a metal housing and an antenna element therein. The table communication device includes a smartphone, a tablet computer, etc.

Description of the Related Art

With advancements in mobile communication technology, more and more communication products are being developed. Among them, mobile communication devices, such as smartphones and tablet computers, are the most popular ones. For these mobile communication devices, the current trend is directed to thin and light appearance. Consumers pay more attention to the devices with a beautiful appearance and robustness. Accordingly, it has become a challenge for antenna engineers to design thin and light mobile communication devices with metal housings, and antenna elements applied to these communication devices.

Generally speaking, the challenge for overcoming the drawbacks of the prior art is how to remove the nonmetallic antenna windows on the metal housings of communication devices. If the design with no antenna window is achieved, the appearance of corresponding communication devices will be improved

### BRIEF SUMMARY OF THE INVENTION

The invention is aimed at designing a communication device with a metal housing (e.g., a smartphone, a tablet computer, etc.) and an antenna element therein, so as to achieve better quality of communication.

In a preferred embodiment, the invention is directed to a communication device including a housing, a system circuit board, and an antenna element. The housing includes a metal plane. The metal plane is disposed on a back surface of the housing. An edge of the metal plane is aligned with an edge of the back surface. The system circuit board includes a ground plane. The antenna element includes a metal piece and a printed circuit board. The metal piece is disposed on a side surface of the housing, and is separated from the metal plane. The metal piece extends along the edge of the metal plane. The metal piece is also separated from the edge of the metal plane by a nonconductive region. The printed circuit board includes a circuit. The printed circuit board has a first connection point and a second connection point. The first connection point is coupled to a signal source. The second connection point is coupled to the metal piece and is used as a first feeding point of the antenna element. The printed circuit board has a vertical projection on the metal plane, and the whole vertical projection is inside the metal plane.

The antenna element of the invention is formed by the metal piece and the printed circuit board. The metal piece is a radiation element. The printed circuit board includes a circuit (e.g., a tuning circuit or a matching circuit). In some embodiments, the circuit of the printed circuit board includes at least one passive circuit element for fine-tuning the impedance matching of the antenna element, thereby increasing the operation bandwidth of the antenna element. In some embodiments, if the passive circuit element is used to fine-tune the impedance matching, the antenna element can cover a first frequency band and a second frequency band. In some embodiments, the first frequency band is from 824 MHz to 960 MHz, so as to cover the operations of GSM (Global System for Mobile Communication) 850, GSM 900, and LTE (Long Term Evolution) Band 5 and Band 8; and the second frequency band is from 1710 MHz to 2690 MHz, so as to cover the operations of LTE and WWAN (Wireless Wide Area Network).

In some embodiments, the aforementioned circuit further includes an active circuit element (e.g., a switch circuit). For example, the active circuit element can switch between different inductive elements, so as to change the total inductance of the circuit. Such a design can fine-tune the resonant frequency and operation frequency band of the antenna element, without changing the total size of the metal piece. Accordingly, the antenna element is capable of covering a wider operation bandwidth. For example, if the active circuit element is used, the first frequency band of the antenna element can further cover a frequency interval from 700 MHz to 824 MHz, thereby covering the LTE 700 frequency band. If the active circuit element and the passive circuit element are both used to fine-tune the impedance matching, the antenna element can cover the first frequency band from 700 MHz to 960 MHz, and the second frequency band from 1710 MHz to 2690 MHz. In other words, the antenna element of the invention can support the high and low frequency operations of LTE and WWAN.

In some embodiments, the metal piece of the antenna element forms a portion of a frame of the housing, and the frame has a rectangular shape. In some embodiments, the spacing between the metal piece and the edge of the metal plane is from 0.5 mm to 3.0 mm. Specifically, the aforementioned spacing is at least 0.5 mm, such that the metal piece is effectively separated from the metal plane, and the aforementioned spacing is at most 3.0 mm, such that the maximum width of the nonconductive region is limited and the aesthetic appearance of the communication device with the metal housing is maintained.

In some embodiments, the metal piece is perpendicular to the metal plane, and the edge of the metal plane is aligned with the edge of the housing. With such a design, the antenna element needs no clearance region on the metal plane. That is, there is no need to dispose any non-metallic antenna window on the metal housing of the communication device. Furthermore, there is also no need to open any slit on the metal plane of the communication device and form a slot antenna structure. In a preferred embodiment of the invention, the housing of the communication device can have a complete metal back cover, so as to maintain the aesthetic appearance of the communication device. It should be noted that according to the practical measurement, the aforementioned design can also prevent the communication device from being negatively affected by being held in the user's hand.

In some embodiments, the printed circuit board is a flexible printed circuit board. By using the flexible printed circuit board, the antenna element does not occupy any area on the system circuit board and the metal housing. This increases the design flexibility to dispose elements in the communication device. In some embodiments, the printed circuit board further has a third connection point, and the third connection point is coupled to the metal piece and is used as a second feeding point of the antenna element. In some embodiments, the printed circuit board further has a grounding point coupled to the ground plane. The incorporation of the aforementioned third connection point and grounding point can increase the design flexibility to feed in the antenna element.

In some embodiments, the above coupling mechanism between any two elements includes direct connection, capacitively-coupled connection, or inductively-coupled connection.

That is, any two connected elements can be directly connected to each other, or can be connected through a capacitor or an inductor to each other.

In some embodiments, the metal piece has a length of 95 mm and a width of 5 mm. The metal piece may be disposed on a side surface of a housing of a tablet device. The metal piece is combined with the printed circuit board so as to form the antenna element, which can cover the high and low frequency operations of LTE/WWAN (e.g., the low frequency band may be from 824 MHz to 960 MHz or from 698 MHz to 960 MHz, and the high frequency band may be from 1710 MHz to 2690 MHz). The antenna element of the invention can be applied to a variety of mobile communication devices with metal housings (in particular to table communication devices) because the antenna element does not need any clearance region on the metal plane and the printed circuit board is not required to be disposed on any region on the metal plane or the system circuit board. The proposed design has the advantages of both a small size and a wide operation bandwidth.

### BRIEF DESCRIPTION OF DRAWINGS

The invention can be more fully understood by reading the subsequent detailed description and examples with references made to the accompanying drawings, wherein:

FIG. 1 is a diagram of a communication device according to an embodiment of the invention;

FIG. 2 is an enlarged view of a metal piece, a printed circuit board, and a metal plane according to an embodiment of the invention;

FIG. 3 is an enlarged view of a printed circuit board according to another embodiment of the invention;

FIG. 4 is a diagram of return loss of an antenna element of a communication device according to an embodiment of the invention;

FIG. 5 is a diagram of antenna efficiency of an antenna element of a communication device according to an embodiment of the invention; and

FIG. 6 is a diagram of return loss of an antenna element of a communication device according to another embodiment of the invention.

### DETAILED DESCRIPTION OF THE INVENTION

In order to illustrate the foregoing and other purposes, features and advantages of the invention, the embodiments and figures of the invention will be described in detail as follows.

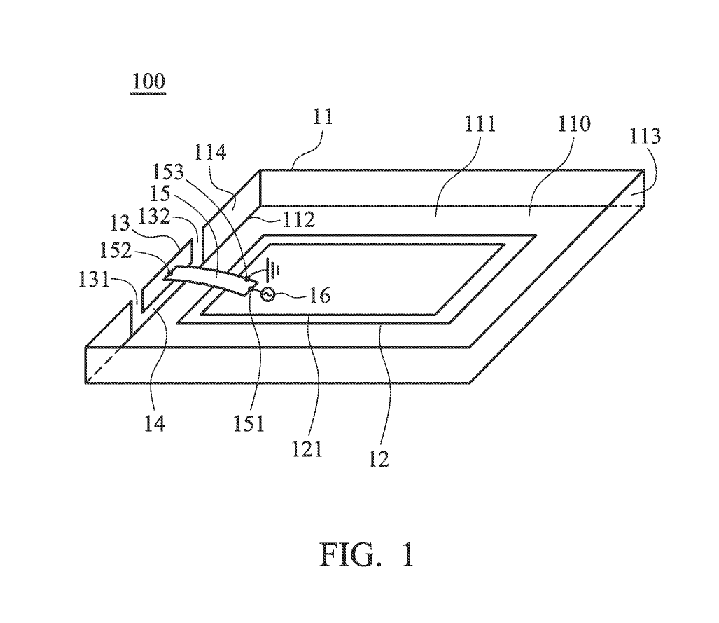

FIG. 1 is a diagram of a communication device 100 according to an embodiment of the invention. The communication device 100 may be a smartphone, a tablet computer, or a notebook computer. As shown in FIG. 1, the communication device 100 includes a housing 11, a system circuit board 12, and an antenna element. The housing 11 includes a metal plane 111. The metal plane 111 is disposed on a back surface 110 of the housing 11. An edge 112 of the metal plane 111 is aligned with an edge of the back surface 110. The system circuit board 12 includes a ground plane 121. The ground plane 121 may have a rectangular shape. The antenna element includes a metal piece 13 and a printed circuit board 15. The metal piece 13 is disposed on a side surface 114 of the housing 11, and is completely separated from the metal plane 111. The metal piece 13 extends along the edge 112 of the metal plane 111. The metal piece 13 is separated from the edge 112 of the metal plane 111 by a nonconductive region 14. The printed circuit board 15 has a first connection point 151 and a second connection point 152. The first connection point 151 is coupled to a signal source 16. The second connection point 152 is coupled to the metal piece 13 and is used as a first feeding point of the antenna element. The printed circuit board 15 may further have a grounding point 153 coupled to the ground plane 121, so as to fine-tune the impedance matching of the antenna element. It should be noted that in the disclosure, the coupling mechanism between any two elements includes direct connection, capacitively-coupled connection, or inductively-coupled connection. That is, any two connected elements can be directly connected to each other, or can be connected through a capacitor or an inductor to each other. The metal piece 13 forms a portion of a frame 113 of the housing 11. The frame 113 may have a rectangular shape. The nonconductive region 14 is arranged to separate the metal piece 13 from the metal plane 111 completely. At least two gaps 131 and 132 are arranged to separate the metal piece 13 from the other portions of the frame 113 completely. It should be noted that the communication device 100 may further include other components, such as a touch control panel, a processor, a speaker, a battery, and a housing (not shown).

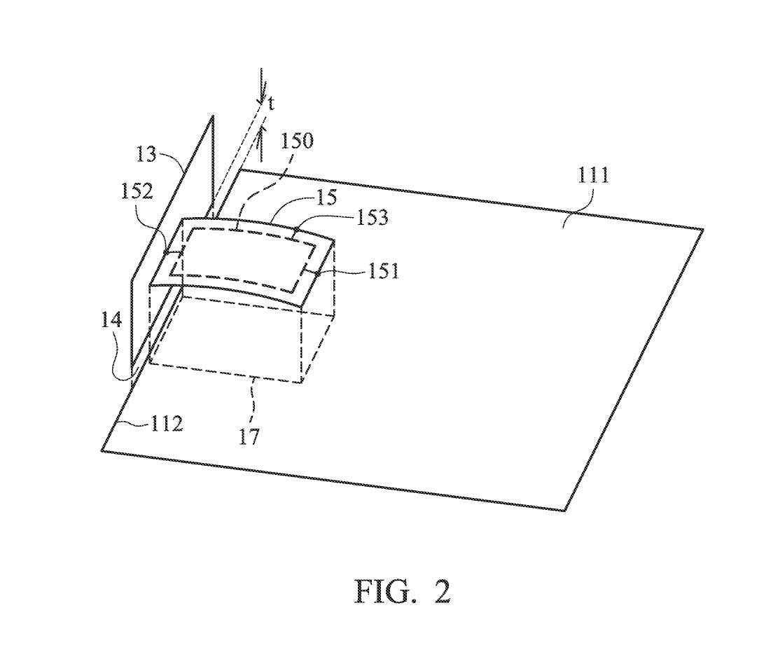

FIG. 2 is an enlarged view of the metal piece 13, the printed circuit board 15, and the metal plane 111 according to an embodiment of the invention. As mentioned above, the antenna element of the communication device 100 includes the metal piece 13 and the printed circuit board 15. The spacing t is formed between the metal piece 13 and the edge 112 of the metal plane 111, and it is from 0.5 mm to 3.0 mm. The printed circuit board 15 further includes a circuit 150 (e.g., a tuning circuit or a matching circuit) for fine-tuning the resonant frequency and the operation frequency bandwidth of the antenna element. The printed circuit board 15 has a vertical projection 17 on the metal plane 111, and the whole vertical projection 17 is inside the metal plane 111.

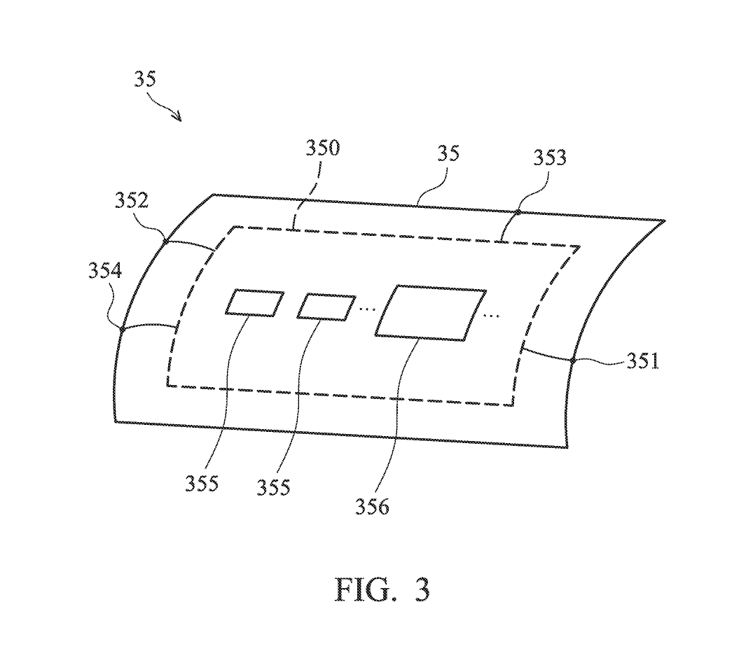

FIG. 3 is an enlarged view of a printed circuit board 35 according to another embodiment of the invention. The printed circuit board 35 may be applied to the aforementioned communication device 100. As shown in FIG. 3, the printed circuit board 35 includes a circuit 350, and has a first connection point 351, a second connection point 352, a grounding point 353, and a third connection point 354. The first connection point 351 is coupled to a signal source. The second connection point 352 is coupled to the metal piece 13 and is used as a first feeding point of an antenna element. The grounding point 353 is coupled to a ground plane. The third connection point 354 is coupled to the metal piece 13 and is used as a second feeding point of the antenna element. Specifically, the first connection point 351 is positioned at a first edge of the printed circuit board 35. The second connection point 352 and the third connection point 354 are both positioned at a second edge of the printed circuit board 35. The grounding point 353 is positioned at a third edge of the printed circuit board 35. The first edge and the second edge of the printed circuit board 35 are opposite to each other. The third edge of the printed circuit board 35 is perpendicular to the first edge and the second edge of the printed circuit board 35. The above dual feeding points can increase the design flexibility to feed in the antenna element and fine-tune the impedance matching of the antenna element. The circuit 35 includes one or more passive circuit elements 355 for increasing the operation frequency bandwidth of the antenna element. In addition, the circuit 350 further includes an active circuit element 356 for changing the resonant frequency of the antenna element, thereby fine-tuning the operation frequency band of the antenna element. The printed circuit board 35 may be a flexible printed circuit board, so as to increase the design flexibility to dispose the antenna element in the communication device 100.

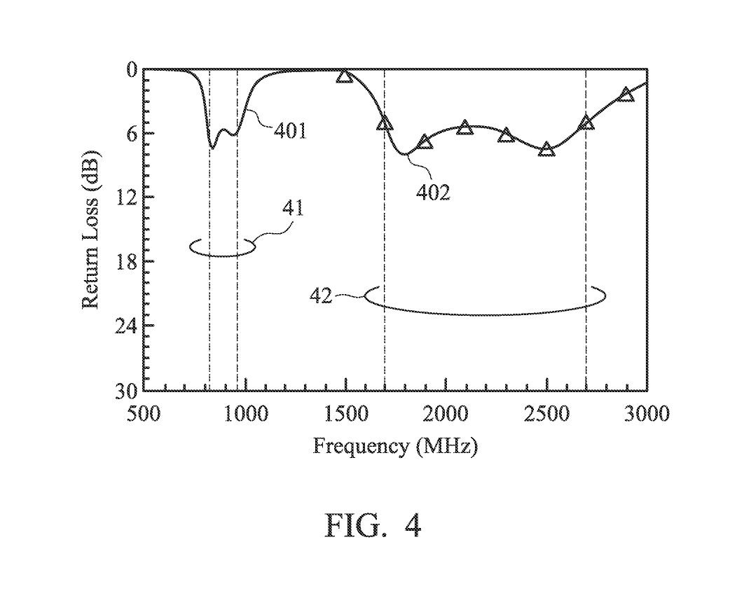

FIG. 4 is a diagram of return loss of the antenna element of the communication device 100 according to an embodiment of the invention. The horizontal axis represents the operation frequency (MHz), and the vertical axis represents the return loss (dB). In some embodiments, the metal plane 111 has a length of 200 mm and a width of 150 mm, and the metal piece 13 has a length of 95 mm and a width of 5 mm. As shown in FIG. 4, the antenna element of the communication device 100 can operate in a first frequency band 41 (as shown in a first curve 401 of return loss) and a second frequency band 42 (as shown in a second curve 402 of return loss). Specifically, the first frequency band 41 can cover the frequency bands of GSM 850/900 and LTE Band 5 and Band 8 (from about 824 MHz to about 960 MHz), and the second frequency band 42 can cover the frequency bands of LTE/WWAN (from about 1710 MHz to about 2690 MHz). In other words, the antenna element of the communication device 100 can support both the high and low frequency operations of LTE and WWAN.

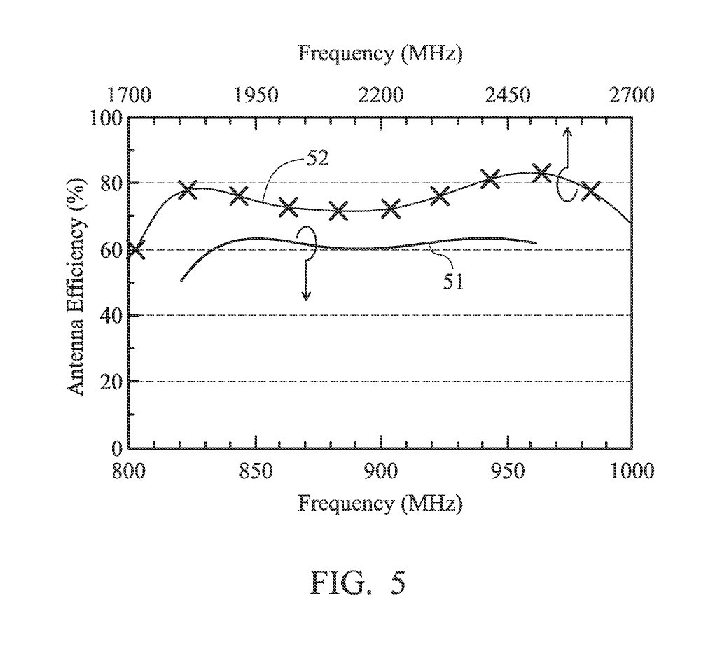

FIG. 5 is a diagram of antenna efficiency of the antenna element of the communication device 100 according to an embodiment of the invention. The horizontal axis represents the operation frequency (MHz), and the vertical axis represents the antenna efficiency (%). As shown in FIG. 5, a first curve 51 of antenna efficiency represents the antenna efficiency of the antenna element operating in the first frequency band 41 (from about 824 MHz to about 960 MHz), and such antenna efficiency is from about 52% to about 63%. A second curve 52 of antenna efficiency represents the antenna efficiency of the antenna element operating in the second frequency band 42 (from about 1710 MHz to about 2690 MHz), and such antenna efficiency is from about 60% to about 83%. According to practical measurements, the antenna efficiency of the invention can meet the requirements of practical application in mobile communication devices.

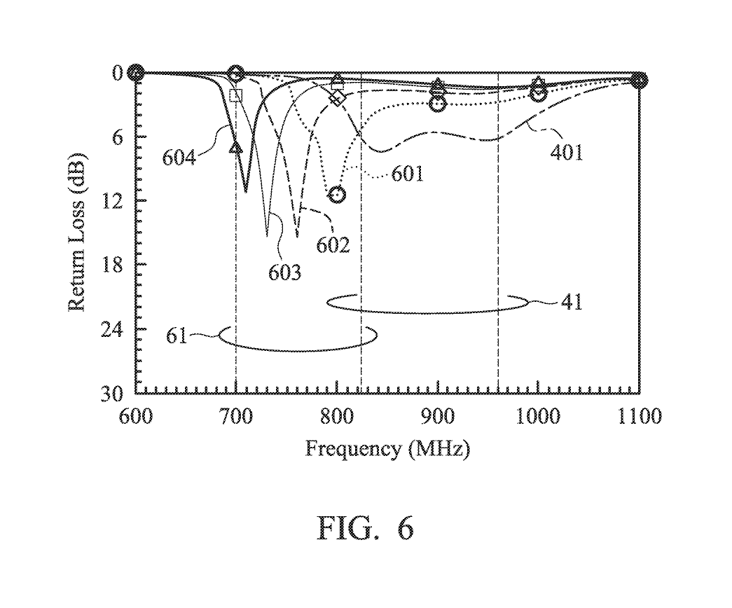

FIG. 6 is a diagram of return loss of the antenna element of the communication device 100 according to another embodiment of the invention. The horizontal axis represents the operation frequency (MHz), and the vertical axis represents the return loss (dB). In the embodiment of FIG. 6, the printed circuit board 35 of FIG. 3 is applied to the communication device 100. As mentioned above, the circuit 350 of the printed circuit board 35 includes one or more passive circuit elements 355 and an active circuit element 356. The passive circuit elements 355 can make the antenna element operate in the first frequency band 41 (as shown in the first curve 401 of return loss). The active circuit element 356 can change the resonant frequency of the antenna element, thereby fine-tuning the operation frequency band of the antenna element (as shown in different curves 601, 602, 603, and 604 of return loss). For example, if the active circuit element 356 (e.g., a switch element) is configured to switch between a variety of inductors, it can provide different inductances for the antenna element, such that the antenna element can additionally cover an operation frequency interval from 700 MHz to 824 MHz (as shown in the additional operation frequency band 61). Accordingly, the low frequency bandwidth of the antenna element including both the passive circuit element and the active circuit element can be effectively widened (e.g., from 700 MHz to 960 MHz), thereby further covering the LTE 700 frequency band.

Note that the above element sizes, element shapes, and frequency ranges are not limitations of the invention. An antenna designer can fine-tune these settings or values according to different requirements. It should be understood that the communication device and antenna element of the invention are not limited to the configurations of FIGS. 1-6. The invention may include any one or more features of any one or more embodiments of FIGS. 1-6. In other words, not all of the features displayed in the figures should be implemented in the communication device and antenna element of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a housing, comprising a metal plane, wherein the metal plane is disposed on a back surface of the housing, and an edge of the metal plane is aligned with an edge of the back surface;
a system circuit board, comprising a ground plane; and
an antenna element, comprising:
a metal piece, disposed on a side surface of the housing, separated from the metal plane, and extending along the edge of the metal plane, wherein the metal piece is separated from the edge of the metal plane by a nonconductive region; and
a printed circuit board, comprising a circuit, wherein the printed circuit board has a first connection point and a second connection point, the first connection point is coupled to a signal source, the second connection point is coupled to the metal piece and is used as a first feeding point of the antenna element, the printed circuit board has a vertical projection on the metal plane, and the whole vertical projection is inside the metal plane.

2. The communication device as claimed in claim 1, wherein the metal piece forms a portion of a frame of the housing, and the frame has a rectangular shape.

3. The communication device as claimed in claim 1, wherein spacing between the metal piece and the edge of the metal plane is from 0.5 mm to 3.0 mm.

4. The communication device as claimed in claim 1, wherein the printed circuit

5. The communication device as claimed in claim 1, wherein the circuit comprises at least one passive circuit element for increasing operation bandwidth of the antenna element.

6. The communication device as claimed in claim 5, wherein the circuit further comprises an active circuit element for changing a resonant frequency of the antenna element, so as to fine-tune an operation frequency band of the antenna element.

7. The communication device as claimed in claim 1, wherein the printed circuit board further has a third connection point, and the third connection point is coupled to the metal piece and is used as a second feeding point of the antenna element.

8. The communication device as claimed in claim 1, wherein the printed circuit board further has a grounding point coupled to the ground plane.

9. The communication device as claimed in claim 1, wherein the antenna element operates in a first frequency band and a second frequency band, the first frequency band is from 824 MHz to 960 MHz, and the second frequency band is from 1710 MHz to 2690 MHz.

10. The communication device as claimed in claim 1, wherein the coupling comprises direct connection, capacitively-coupled connection, or inductively-coupled connection.

11. The communication device as claimed in claim 7, wherein the coupling comprises direct connection, capacitively-coupled connection, or inductively-coupled

12. The communication device as claimed in claim 8, wherein the coupling comprises direct connection, capacitively-coupled connection, or inductively-coupled
